(19) United States
(12) Patent Application Publication
(10) Pub. No.: US 2021/0069997 A1
(43) Pub. Date: Mar. 11, 2021

(54) METHOD FOR MANUFACTURING A COMPOSITE MATERIAL STRUCTURE USING A COCURING PROCESS

(71) Applicant: Airbus Operations S.L.U., Getafe (ES)

(72) Inventors: Augusto PÉREZ PASTOR, Getafe (ES); Francisco Javier CHAMORRO ALONSO, Getafe (ES); Aquilino GARCÍA GARCÍA, Getafe (ES); Jorge Juan GALIANA BLANCO, Getafe (ES); Pedro NOGUEROLES VIÑES, Getafe (ES)

(21) Appl. No.: 17/011,369

(22) Filed: Sep. 3, 2020

(30) Foreign Application Priority Data
Sep. 5, 2019 (EP) 19382760.7

(51) Int. Cl. B29C 70/44; B29C 70/30; B29C 70/68; B29C 70/54; B64C 3/18; B64C 3/26

(52) U.S. Cl. CPC B29C 70/44; B29C 70/30; B29C 70/682; B29K 2105/0872; B64C 3/182; B64C 3/26; B29C 70/545

(57) ABSTRACT

A method for manufacturing a structure by curing together a base laminate and structural components placed thereon. Particularly, the uncured structural component has a peripheral tapered foot edge so that the vacuum bag placed thereon follows all the uncured plies without an abrupt leap from the structural component foot to the base laminate.

### CROSS-REFERENCES TO RELATED APPLICATIONS

This application claims the benefit of the European patent application No. 19382760.7 filed on Sep. 5, 2019, the entire disclosures of which are incorporated herein by way of reference.

### FIELD OF THE INVENTION

The present invention belongs to the field of manufacturing composite parts, and particularly, the invention provides a method for manufacturing a structure by curing together a base laminate and structural components placed thereon.

Accordingly, an object of the present invention is to provide at least one uncured structural component with a peripheral tapered foot edge so that the vacuum bag placed over follows all the uncured plies without an abrupt leap from the structural component foot to the base laminate.

In advantageous embodiments, a vacuum bag is formed by joining strips or bands that surround the structural components with complementary pieces of the same material resulting in a vacuum bag which extends over the entire uncured base laminate.

### BACKGROUND OF THE INVENTION

Structural components are normally used as stiffeners for adding rigidity and strength to adjacent load carrying panels or skin. An example of such structural components are ‘T-profile’ or ‘Ω-profile’ (‘omega’) stringers, which prevent the skin of an aircraft from buckling or bending under compression or shear loads. In addition, these structural (e.g., stiffening) components may transfer aerodynamic loads acting on the skin—of the wing, fuselage section, etc.—onto other supporting structure such as frames, beams, or ribs.

The resulting structure (stiffened panels or skin) is typically made of composite material by well-known co-bonding methods wherein these structural components (e.g., stringers) in uncured state (i.e., made of stacked ‘pre-preg’ plies) are joined to a skin or panels in cured state (i.e., already subjected to a curing cycle).

For example, a ‘T-profile’ stringer is conventionally formed by two halves in ‘L-shape’, which afterwards are joined together. Each half may be the mirror image of the other and are positioned in such a way that both rest on each other, placing their respective webs in contact.

The resulting T-profile composite part is theoretically divided in a web (formed by respective webs of the ‘L-shape’ halves) and the two feet, wherein each foot points in an opposite direction. Once installed, the feet contact the skin or panels leaving the web projecting out the surface of the skin.

On the other hand, an ‘omega-stringer’ has a substantially trapezoidal profile with an open side, from the ends of which two feet extend outwards pointing in opposite directions (so-called stringer foot). The stringer is joined to the skin or panels via this foot. Like the ‘T-profile’ stringer, the omega-stringers are normally co-bonded to a cured skin or panels.

US patent application 2016/0318238 discloses a co-bonding process used on stiffened lifting surfaces. In other words, the co-bonding method entails two curing cycles, whether both composite parts are cured together and then adhesively bonded, or one part is firstly cured and the other part positioned and cured thereon as the above patent document describes.

In the latter scenario of a typical co-bonding method, the first curing cycle is used to independently consolidate either the base laminate or the stringers. Then, the second curing cycle completes the mutual integration by curing and bonding the remainder part to the already cured one.

Although this two-curing step approach—co-bonding method—is a mature and reliable technology entailing a robust industrial solution, it is not cost-effective due to the extra labor (semi-finished parts rolling-over different stages) and energy consumption (autoclaves/ovens, raw materials, storing, etc.) associated with two curing cycles. Moreover, bonding requires the placement of an interposing adhesive film layer, along with a proper surface treatment (normally achieved by an additional pre-preg peel ply) to assure correct bonding to the pre-cured part.

Co-curing manufacturing methods, which involve curing together both uncured parts, reduces lead time up to reasonable levels. Nevertheless, this manufacturing method is exclusive to the simplest geometries, because of low quality achieved due to the difficulty of avoiding prints and undulations in sites where geometry changes. This drawback is stressed in aeronautics, where prints or undulations create weak areas which may affect the structural integrity.

For instance, to mold the stringer webs in an uncured state, it is necessary to use rigid caul plates. In particular, the areas where these rigid caul plates end entail a high risk of creating undesirable wrinkles or undulations in co-curing methods. Consequently, the final stiffened panels or skin stress drops down significantly, discarding this technology so far.

Thus, since manufacturing of structural components (e.g., stringer manufacturing) is a mass-production, critical, labor-intensive, multi-step process that requires high quality or tight dimensional tolerances; nowadays, with co-bonding methods, the combination of a number of steps and the high precision required may cause delays prompting a drawback for the aeronautical industry.

Consequently, there is a need for reducing composite structure—stiffened panels or skin—lead times without jeopardizing structural quality of the final structure.

### SUMMARY OF THE INVENTION

The present invention provides a solution for the aforementioned problems by a method for manufacturing by co-curing a structure of composite material formed by at least one structural component positioned on a base laminate.

In a first inventive aspect, the invention provides a method for manufacturing a composite material structure using a co-curing process, the structure being formed by at least one structural component positioned on a base laminate, the method comprising the following steps:

a) for each uncured structural component, manufacturing it by laying-up and forming steps so that the structural component comprises a foot adapted to contact on the base laminate wherein such foot comprises a peripheral tapered edge; each uncured structural component being surrounded by a vacuum strip secured between curing tools;

b) positioning each of the at least one uncured structural components on an uncured base laminate in the areas foreseen for the attachment, and forming a vacuum bag together with complementary pieces of the same material, so that the resulting vacuum bag extends over the entire uncured base laminate;

c) applying a curing cycle to the assembly resulting from the previous step for curing together each of the at least one structural components with the base laminate, the composite material structure being manufacturing thereby.

It is to be noted that each uncured structural component is surrounded by a strip of vacuum bag in such a way that, once the structural component(s) is/are positioned, the resulting vacuum bag extending over the entire uncured base laminate may be formed by joining said strips with such complementary pieces of the same material. Otherwise, this vacuum bag may be provided as a single piece with an extension suitable for covering the whole uncured base laminate as well as all uncured structural components—placed thereon—envisaged (the vacuum strips and complementary pieces thereof being understood as delimited areas of the bigger single bag.

The base laminate is understood as a thin composite structural element that provides the outer surface of the structure. Typically, a number of composite plies (i.e., pre-preg) are laid-up one upon the other in a flat manner, thus resulting in a stack of plies.

If necessary, this stack of plies—uncured base laminate—may be trimmed to the desire shape. The resulting planar laminate (trimmed or not) is known as a composite pre-form.

Similarly, the manufacturing of uncured structural component(s) encompasses the laying-up of pre-preg plies and further includes a forming-up process so as to obtain the desired cross-sectional shape or profile of the structural component (e.g., a stringer).

For instance, if the structural component has a ‘T-profile’, two separate planar laminates, each corresponding to a single ‘L-shape’ half, may be bent between the web and the foot in order to form-up two ‘L-profiles’. Typical forming-up technologies for this process are hot forming and press-forming; wherein hot-forming uses a membrane and heat, while the press-forming uses a press and force. Then, both formed-up ‘L-profiles’ are positioned and put together making their respective webs contact symmetrically for achieving the desired ‘T-profile’.

On the other hand, recent developments try to form the ‘T-profile’ in a single step.

Be that as it may, once the forming step is completed, the manufacturing of the uncured structural component results in the uncured structural component being surrounded by a strip of vacuum bag secured between curing tools.

That is, there is an ensemble for each structural component wherein the laid-up and formed-up preform is wrapped, except for the base of the foot, by a vacuum strip arranged between such curing tools.

Nevertheless, unlike conventional structural component manufacturing where the foot edge is straight (i.e., the edge is perpendicular to the base laminate once positioned), the present invention provides the structural component foot with a peripheral tapered edge so that the vacuum bag can adhere to it, as there is a progressive transition towards the base laminate avoiding sudden leaps which might suction beneath it (in the generated void).

Accordingly, once the vacuum bag is extended over such a transition, there are no empty spaces causing suction of the base laminate (source of undulations creation) by the present invention. Therefore, this peripheral tapered shape (i.e., a ramp for the vacuum bag arrangement) prevents the creation of undulations on the skin laminate close to the structural component edge.

Thus, the invention provides a reliable manufacturing process using one single curing cycle for the integration of structural components with complex shape (stringers) on a base laminate already molded on a tool (as the base laminate is also uncured) replicating the aero-shape of the external surface of a lifting surface part.

Furthermore, it provides the following advantages:

reduction of labor, waste, energy consumption and manufacturing lead time as the composite structure is manufactured in one-shot;

avoidance of adhesive bond failures;

tight thickness tolerances; and

Preferably, the peripheral tapered foot edge is created during the bending step—step (a)—of the foot from the flat laminate by the sliding of the plies. Other advantageous embodiments will be described hereinafter.

For instance, in a particular embodiment, step (a) further comprises laying-up staggered pre-preg plies on the foot edge area to form the peripheral tapered foot edge. In other words, a special peripheral tapered foot edge geometry may be created during step (a) by laying up the pre-preg plies starting at different positions on the foot edge area.

In a preferred embodiment, step (a) further comprises trimming the peripheral foot edge of the at least one structural component to form the peripheral tapered foot edge.

Advantageously, this allows a ready, adaptable and easy to implement manufacturing process.

In a particular embodiment, the step (a) further comprises manufacturing separately the at least one structural component and joining adjacent to its peripheral foot edge an uncured wedge to form the peripheral tapered foot edge.

This uncured composite wedge may be similar to a rowing or composite filler. It is normally understood as a bundle of fibers which may be unidirectional and unspun or otherwise shaped into patterns to provide structural continuity and void avoidance.

This composite wedge may be manufactured independently, being afterward placed adjacent to the peripheral foot edge of the structural component. Without prejudice of the peripheral foot edge being either straight or tapered, the composite wedge compensates it to achieve a correct inclination.

Advantageously, it allows a simpler manufacturing tooling of the structural component thus enabling a reduction on the development lead time and with high capacity to adapt late design changes.

In a particular embodiment, the step (b) further comprises laying-up additional pre-preg plies in a non-planar manner covering at least the peripheral tapered foot edge so that the thresholds are offset.

By laying-up the pre-preg plies horizontally, a staircase effect is produced due to the approximation of angles, which is compensated or offset by the additional pre-preg plies deposited over them. In other words, the staircase effect is the result of the approximation of surfaces at an angle by the pre-preg ply thickness as the height of a step during manufacturing.

A collateral advantage of this embodiment is that the mechanical properties of the foot edge are also improved in the Z-direction, i.e., substantially perpendicular to the base laminate.

In a preferred embodiment, the step (b) further comprises laying-up the uncured base laminate on a mold shaping an aerodynamic surface, so that the base laminate is preferably a portion of an aircraft skin.

As they are laid-up over a depositing mold shaping an aerodynamic surface, the uncured base laminate comprises a lower aerodynamic face-sheet built by successive plies.

The structural components, if more than one, are all positioned on the opposite face to the aerodynamic face-sheet.

In a particular embodiment, at least one structural component is a reinforcing longitudinal stringer such as a T-profile stringer or an omega-profile stringer.

As mentioned, an omega-profile stringer is a common semi-tubular stiffening component or stringer in aeronautics.

Regarding the omega-profile stringer, the curing tool may be either a male tool (also known as ‘mandrel’ such as barrel-type), a female tool, or both.

In a particular embodiment, if the reinforcing longitudinal stringer is a T-profile stringer, the curing tools are two angular profiles adapted to a shape the T-profile stringer. In a preferred embodiment, these two angular profiles are two L-profile caul plates.

The specific angle depends on the angle finally formed between the web and foot of the ‘T-profile’ stringer.

In a particular embodiment, the curing tools are made of a material able to maintain a stable shape at the solidification temperatures of the composite matrix, such as steel or INVAR alloy.

For instance, the composite matrix may be a thermoplastic or thermosetting polymer such as epoxy resin.

In a particular embodiment, the vacuum strips and the complementary pieces for forming jointly a vacuum bag comprise an impervious plastic film. The internal side of the impervious plastic film, that is, the one facing the composite part, may be either treated with a release agent or covered by a release film.

The impervious plastic film is the outer vacuum bag from which the air is evacuated by the pump. This film is tear resistant and sticks well to a bag sealing tape.

The release film is a plastic film configured not to stick to the composite laminate. Further, the release film may have a matte finish to improve the superficial appearance.

In a preferred embodiment, a breather tissue is arranged between the impervious plastic film and the release film. A breather tissue is a type of porous fabric promoting movement of gases inside the vacuum bag.

In a particular embodiment, at least one complementary piece comprises a first portion of the same width as the vacuum strips, and a second portion adapted to cover the remainder region of the base laminate.

Advantageously, this reduces manufacturing costs.

In a particular embodiment, both the at least one vacuum strip and the first portion of the at least one complementary piece comprise sealing tapes applied at any or both of the respective side edges thereof, so that contiguous strips and first portions of the complementary pieces are in contact by the sealing tapes in order to facilitate the union between the vacuum strip and the first portion of a complementary piece.

The bag sealing tape is an especially sticky, gum-like tape for perfectly sealing two edges of a vacuum bag or between the vacuum bag and a mold.

In a particular embodiment, in step (a) lateral edges of the vacuum strips are fixed to the curing tools in order to ensure proper alignment of the vacuum strips during the placement of the uncured structural component on the base laminate.

In a second inventive aspect, the invention provides a structure of composite material formed by at least one structural component positioned on a base laminate manufactured by the method according to any of the embodiments of the first inventive aspect.

In short, the most remarkable feature of the composite structure formed by the method according to the invention is the presence of a peripheral tapered foot edge of the at least one structural component as well as the avoidance of undulations on the base laminate close to such foot edge.

All the features described in this specification (including the claims, description and drawings) and/or all the steps of the described method can be combined in any combination, with the exception of combinations of such mutually exclusive features and/or steps.

### BRIEF DESCRIPTION OF THE DRAWINGS

These and other characteristics and advantages of the invention will become clearly understood in view of the detailed description of the invention which becomes apparent from a preferred embodiment of the invention, given just as an example and not being limited thereto, with reference to the drawings.

FIG. 1 shows a schematic plan view of a composite structure (stiffened skin) formed by a base laminate (an aircraft wing cover) on which a plurality of structural components (stringers) are positioned.

FIG. 2 shows a schematic cross-sectional representation of a conventional stringer foot edge cured together with a base laminate (conventionally co-cured).

FIGS. 3a-3b show (a) a ‘T-profile’ stringer, and (b) an ‘omega-profile’ stringer placed on a base laminate.

FIGS. 4a-4c show an embodiment of a structural component according to the present invention and two detailed views of different peripheral tapered foot edges.

FIGS. 5a-5b show (a) a schematic plan view of the composite structure before subjecting it to the curing cycle illustrating in particular the strips and complementary pieces with which the vacuum bag is formed; and (b) a partial side view of an embodiment of the strip and complementary piece according to the invention.

### DETAILED DESCRIPTION OF THE PREFERRED EMBODIMENTS

The skilled person in the art recognizes that aspects of the present invention described hereinafter may be embodied either as a method for manufacturing by co-curing a composite structure (10), or the composite material structure (10) itself.

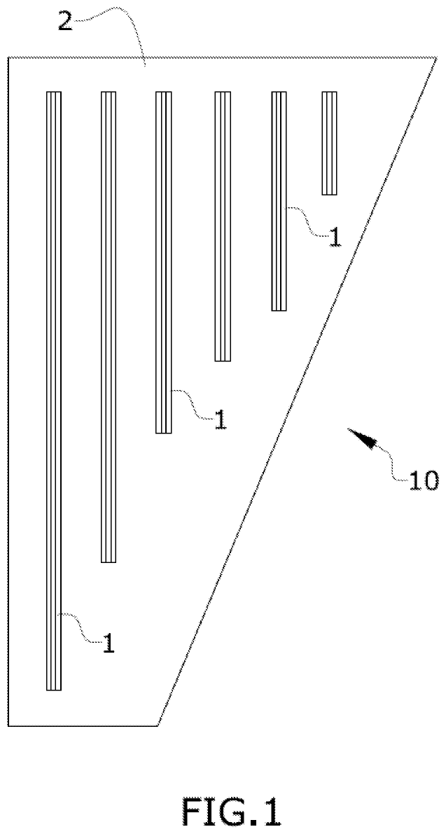

A manufacturing method of a structure (10) such as a cover of an aircraft wing (see FIG. 1) formed by a skin of composite (i.e., the base laminate (2)) stiffened by T-profile stringers made of composite (i.e., the structural components (1)) will now be described.

In aeronautics, structural components (1) are typically placed span-wise the wing.

Such method comprises the basic following steps:

a) for each uncured structural component (1), manufacturing it by laying-up and forming steps so that the structural component (1) comprises a foot (1.1) adapted to contact on a base laminate (2) wherein such foot (1.1) comprises a peripheral tapered edge (1.1.1); each uncured structural component (1) being surrounded by a strip (3) of vacuum bag secured between curing tools (not shown in these figures);

b) positioning each of the at least one uncured structural components (1) on an uncured base laminate (2) in the areas foreseen for the attachment, the vacuum strip (3) of each uncured structural component (1) forming a vacuum bag with complementary pieces (4.1, 4.2) of the same material so that the resulting vacuum bag extends over the entire uncured base laminate (2);

c) applying a curing cycle to the assembly resulting from the previous step for curing together each of the at least one structural components (1) with the base laminate (2), manufacturing the structure (10) thereby.

In particular, the uncured structural component (1) is manufactured by laying up pre-preg plies on a flat laminate, followed by a forming process where the web or the foot bends to the shape of the desired profile.

The forming process can be achieved either by a conventional diaphragm vacuum forming, by dedicated tooling where the laminate is enclosed heated and moved in a controlled way or by continuous forming methods.

As mentioned, the tapered foot edge may be achieved either by the forming process (if the foot bends from the flat laminate), by a special lay-up arrangement where each ply starts in a different position (‘staggered’) or by trimming the laminate foot edge with an appropriate angle.

Then, the manufactured structural component (1), still uncured and wrapped by the vacuum strip (3) (and secured between curing tools), is positioned on the uncured base laminate (2) (already molded on a mold shaping the outer aerodynamic surface). Positioning of the structural components (1)—stringers—may be performed one by one or in groups, using dedicated handling and positioning tools which are properly referenced, for instance to the base laminate or base tool.

It can be noted that the sum of an uncured structural components (1) surrounded by the vacuum strip (3), except on the foot, and in turn secured between curing tools is known as an ‘ensemble’.

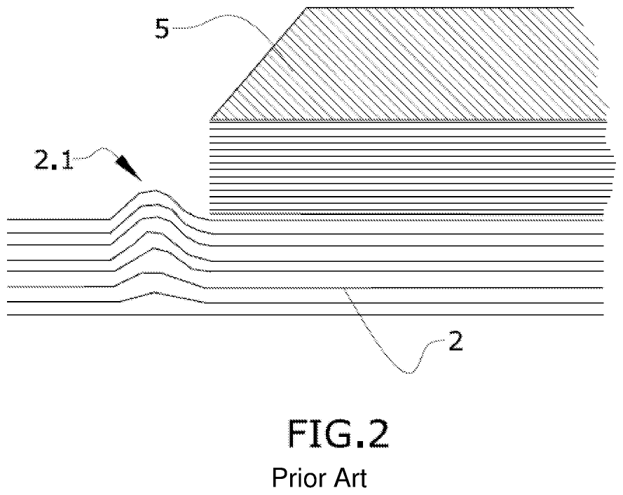

FIG. 2 depicts a schematic cross-sectional representation of a conventional straight—stringer foot edge co-cured with a base laminate (2). It can be seen that the foot edge is formed by the edges of the stacked plies originally forming the uncured preform. These plies are compressed by a stringer molding tool (5) that keeps them in position.

The curing tool (5) function is primarily preventing the deviation of the web (1.2) from the vertical plane and aiding the vacuum bag matching, as closely as possible, to the radius of the structural component. In some embodiments, especially with ‘T-profile’ stringers, curing tool (5) does not cover the top of the web (1.2).

Applying one single curing cycle for the integration of the stringers (1) shown in FIG. 2 with the base laminate (2) (i.e., co-curing) causes prints and undulations (2.1) on the skin (2) once cured, particularly in areas where the stringer molding tool (5) ends close to the peripheral stringer foot edge.

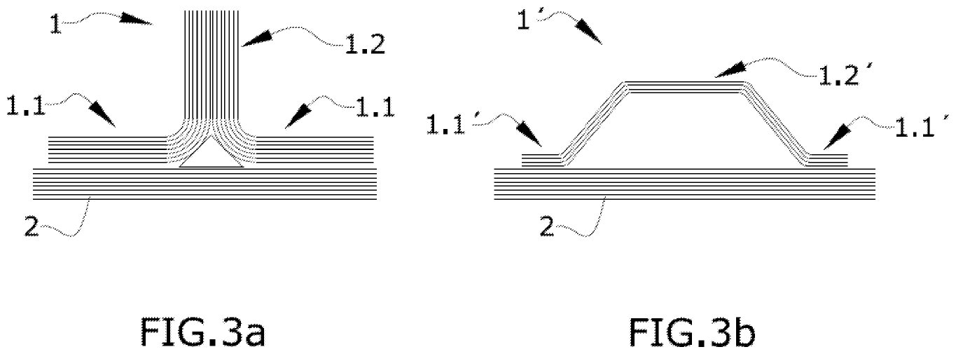

FIGS. 3a and 3b depicts two stringers (1, 1′) with a different cross-sectional profile commonly used in aeronautics. Particularly, FIG. 3a shows a ‘T-profile’ stringer (1), while FIG. 3b shows an ‘omega-profile’ stringer (1′), both placed on a base laminate (2).

The ‘T-profile’ stringer (1) (see FIG. 3a) formed by stacked plies comprises:

a web (1.2), projecting perpendicular to the base laminate (2); and

two foot (1.1), each pointing in opposite direction, serving as a resting for the ‘T-profile’ stringer on the base laminate (2)

Once installed, the foot (1.1) has a surface adapted to contact the base laminate (2) which extends up to the peripheral foot edge.

Regarding the ‘omega-profile’ stringer (1′) (see FIG. 3b), it is formed by a substantially trapezoidal profile with an open side, from the ends of which two feet (1.1′) extend outwards pointing in opposite directions. The isosceles trapezoidal profile may be understood as the web (1.2′) of the ‘omega-profile’ stringer (1′).

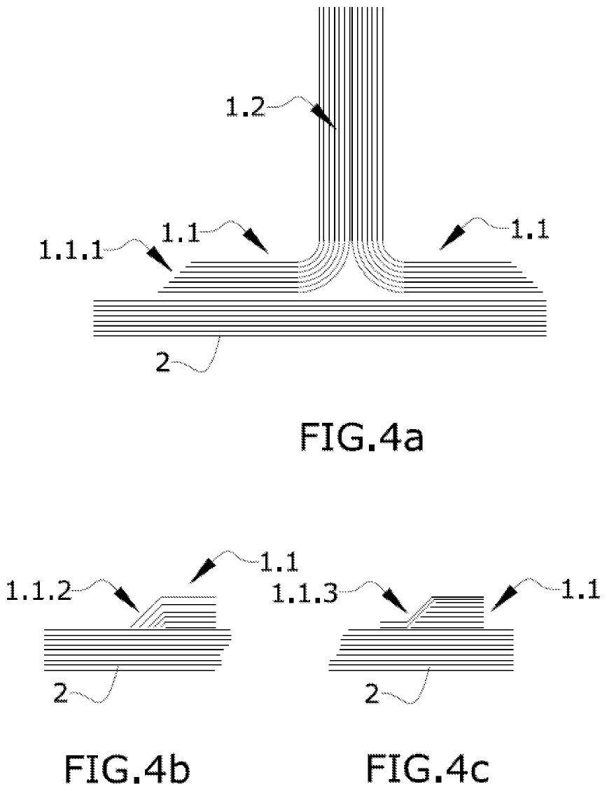

FIG. 4a depicts an embodiment of a structural component (1) placed on a base laminate (2) according to the present invention. In particular, it is shown a ‘T-profile’ stringer (1) with a peripheral tapered foot edge (1.1.1).

For exemplary purposes, only a ‘T-profile’ stringer (1) will be depicted, but it is also applicable to the peripheral tapered foot edge of an ‘omega-profile’ stringer (1′) as shown in FIG. 3b.

As mentioned, this tapered or chamfered edge shape creates a smooth transition for the vacuum bag (4.1, 4.2) and prevents bridging and sinking of these edges on the base laminate (2). Thus, the undesirable effect (2.1) shown in FIG. 2 is avoided along the peripheral foot edge, which represented a weakness on the performance of the co-cured structure. Unlike that, the co-cured stiffened panels (10) as the one shown in FIG. 4a meet the quality levels acceptable in the aircraft industry.

FIG. 4b depicts a tapered edge (1.1.1) achieved either by laying up the foot edge creating this staircase pattern or by a trimming operation with an appropriate angle.

This staircase pattern created on the foot edge by following a staggered laying-up scheme may be performed either by leaving the longest plies close to the base laminate once positioned thereon; or in an inverted staggering (i.e., the shortest plies close to the base laminate) and performing a compaction on the foot edge to form the peripheral tapered foot edge (1.1.1). That is, bringing the longest plies to the base laminate by the compaction to form a ramp.

Alternatively, the peripheral tapered foot edge (1.1.1) is formed by an uncured wedge (1.1.2) positioned adjacent to a straight peripheral foot edge of a stringer (1).

Further, FIG. 4c depicts additional plies (1.1.3) laid-up so as to cover the peripheral foot edge of the stringer (1).

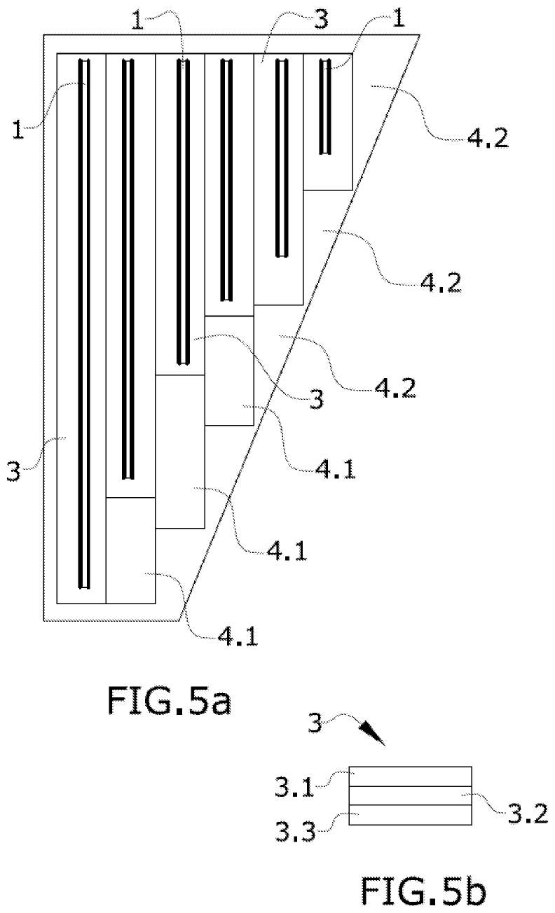

FIG. 5a depicts a schematic plan view of the composite structure (10) before subjecting it to the curing cycle.

In some embodiments, the lateral edges of the vacuum strips (3) are fixed to an assembly tool where the curing tools are located. To do so, a strip (3) is firstly placed on the curing tool and fixed to said assembly tool. Then, in a second step, such preform is placed within the strip (3), being surrounded thereby. It is to be noted that the underneath surface of the foot of the stringer (the one to be in contact with the base laminate) is not surrounded by this vacuum strip (3).

By keeping the lateral edges of the strip fixed to the assembly tool during placement of the uncured structural component (1) on the base laminate (2), the alignment of the strip (3) with the web (1.2) of the structural component (1) is guaranteed.

It is to be noted that strips (3) are adapted to the geometry of the uncured structural components (1) so as to avoid the so-called ‘bridges’ that may cause breakage of the vacuum bag during the curing cycle.

Upon positioning of the ensembles on the base laminate (2) (both in uncured state), the vacuum bag is formed for the whole assembly by joining the vacuum bag strips (3) provided with each structural component (1) (within each ensemble) with the complementary pieces (4.1, 4.2) in order to cover the whole base laminate (2) extension.

As it can be seen, the complementary piece(s) comprise(s) a first portion (4.1) of the same width as the vacuum strips (3), and a second portion (4.2) adapted to cover edge region of the base laminate (2).

The first portion (4.1) of the complementary pieces is deemed as a continuation of the vacuum strips (3) of those structural components (1) that do not extend to the entire available length of the base laminate (2); and the second portion (4.2) thereof are deemed as supplementary pieces required to complete the vacuum bag covering all the base laminate (2) extension.

The vacuum strip(s) (3) as well as the first portion (4.1) of the complementary piece(s) may comprise sealing tapes (not shown) at any or both side edges.

Therefore, after placing the structural components (1) on the base laminate (2), the vacuum bag is formed joining the strips (3) and the first (4.1) (and second (4.2)) portions of the complementary pieces for each structural component (1) by their contiguous side edges by means of such sealing tapes.

FIG. 5b depicts a partial side view of an embodiment of the strip (3) (or complementary piece (4.1, 4.2)) according to the invention.

In particular, the vacuum strips (3) and the complementary pieces (4.1, 4.2) for forming a vacuum bag comprise an impervious plastic film (3.1) with the internal side treated with a release agent or covered by a release film (3.3), A breather tissue (3.2) can be arranged between these two films to improve vacuum stability during laminate consolidation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a composite material structure using a co-curing process, the structure being formed by at least one structural component positioned on a base laminate, the method comprising the following steps:
a) for each uncured structural component, manufacturing the uncured structural component by laying-up and forming steps so that the structural component comprises a foot configured to contact the base laminate, wherein such foot comprises a peripheral tapered foot edge, each uncured structural component being surrounded by a vacuum strip secured between curing tools;
b) positioning each of the at least one uncured structural components on an uncured base laminate in areas foreseen for an attachment and to form an assembly, the vacuum strip of each uncured structural component forming a vacuum bag with complementary pieces of the same material, so that the resulting vacuum bag extends over the entire uncured base laminate;
c) applying a curing cycle to the assembly resulting from step b) for curing together each of the at least one structural components with the base laminate, manufacturing the composite material structure thereby.

2. The method according to claim 1, wherein step a) further comprises laying-up staggered pre-preg plies on a foot edge area to form the peripheral tapered foot edge.

3. The method according to claim 1, wherein step a) further comprises trimming a peripheral foot edge of the at least one structural component to form the peripheral tapered foot edge.

4. The method according to claim 1, wherein step a) further comprises manufacturing separately the at least one structural component and joining adjacent to its peripheral foot edge an uncured wedge to form the peripheral tapered foot edge.

5. The method according to claim 1, wherein step b) further comprises laying-up additional pre-preg plies in a non-planar manner covering at least the peripheral tapered foot edge so that thresholds are offset.

6. The method according to claim 1, wherein step b) further comprises laying-up the uncured base laminate on a mold shaping an aerodynamic surface, so that the base laminate is a portion of an aircraft skin.

7. The method according to claim 1, wherein at least one structural component is a reinforcing longitudinal stringer.

8. The method according to claim 1, wherein the at least one structural component is a T-profile stringer.

9. The method according to claim 1, wherein the at least one structural component is an omega-profile stringer.

10. The method according to claim 7, when the reinforcing longitudinal stringer is a T-profile stringer, wherein the curing tools are two angular profiles, adapted to a shape of the T-profile stringer.

11. The method according to claim 10, wherein the two angular profiles comprise two L-profile caul plates.

12. The method according to claim 1, wherein the curing tools are made of a material able to maintain a stable shape at a solidification temperature of a matrix of the composite.

13. The method according to claim 12, wherein the curing tools are made of steel.

14. The method according to claim 12, wherein the curing tools are made of INVAR alloy.

15. The method according to claim 1, wherein the vacuum strips and the complementary pieces for forming jointly the vacuum bag comprising an impervious plastic film with an internal side either treated with a release agent or covered by a release film.

16. The method according to claim 15, wherein a breather tissue is arranged between the impervious plastic film and the release film.

17. The method according to 1, wherein at least one complementary piece comprises a first portion of the same width as a vacuum strip, and a second portion adapted to cover a remainder region of the base laminate.

18. The method according to claim 15, wherein both the at least one vacuum strip and said first portion of the at least one complementary piece comprises sealing tapes applied at any or both of the respective side edges thereof, so that at least one of contiguous strips or first portions of the complementary pieces are in contact by the sealing tapes in order to facilitate a union between the vacuum strip and the first portion of a complementary piece.

19. The method according to claim 1, wherein in step a) lateral edges of the vacuum strips are fixed to an assembly tool where the curing tools are placed, to ensure proper alignment of the vacuum strips during a placement of the uncured structural component on the base laminate.

20. A composite material structure formed by at least one structural component positioned on a base laminate manufactured by the method according to claim 1.
